(19) United States
(12) Patent Application Publication
(10) Pub. No.: US 2026/0250454 A1
(43) Pub. Date: Aug. 27, 2026

(54) POLYMER COMPOSITION WHICH CAN BE CURED AT ROOM TEMPERATURE AND WHICH IS MADE OF POLYALDEHYDE AND POLYMALONATE

(71) Applicant: SIKA TECHNOLOGY AG, Baar (CH)

(72) Inventors: Andreas KRAMER, Zürich (CH); Hans HÄBERLE, Gailingen (DE); Urs BURCKHARDT, Zürich (CH); Ursula Stadelmann, Zürich (CH)

(73) Assignee: SIKA TECHNOLOGY AG, Baar (CH)

(21) Appl. No.: 18/875,809

(22) PCT Filed: Jun. 21, 2023
(86) PCT No.: PCT/EP2023/066823

§ 371 Date: Dec. 17, 2024

(30) Foreign Application Priority Data
Jul. 13, 2022 (EP) 22184831.0

(51) Int. Cl. C08G 6/02; C09D 161/02; C09J 161/02; C09K 3/10

(52) U.S. Cl. CPC C08G 6/02; C09D 161/02; C09J 161/02; C09K 3/10; C09K 2200/067

(57) ABSTRACT

A curable composition includes—a first component containing aldehyde group-containing compounds which include at least one compound with two or more aldehyde groups and—a second component containing malonate group-containing compounds which include at least one compound with two or more malonate groups of the formula (I), wherein the average molecular weight Mₙ of at least one of the two components, with respect to the aldehyde or malonate group-containing compounds, ranges from 400 to 20,000 g/mol. The composition is largely free of toxicologically concerning ingredients and cures in ambient conditions using conventional catalysts quickly and in a trouble-free manner in order to form a non-tacky elastic polymer with a high degree of strength and elasticity. The composition is particularly suitable for use as an elastic adhesive, sealant, or coating with a high degree of robustness during production, storage, and processing as well as a high degree of resistance after curing.

### TECHNICAL FIELD

The invention relates to two-component compositions and to the use thereof as room temperature curable elastic adhesives, sealants or coatings.

### PRIOR ART

Reactive polymer compositions that are curable at room temperature and can be used as adhesives, sealants or coatings with elastic properties are known. Polyurethane systems that cure through the reaction of isocyanate groups with polyols and/or moisture and form particularly highly elastic polymers are in widespread use. The formulation, production and use of polyurethane systems in practice constitutes a series of challenges. They usually contain considerable amounts of monomeric diisocyanates that can exert an irritant effect on the eyes, skin and mucous membranes. The moisture sensitivity of the isocyanate groups can lead to premature crosslinking reactions associated with increasing viscosity extending as far as gelation, and hence impair shelf life or storage stability. In the case of systems formulated in one-component form, the water required for the curing must penetrate from the outside in the form of air humidity, which complicates use in thick layers or between moisture-tight substrates. In the case of two-component systems with a polyol component and an isocyanate component, the problem exists that the isocyanate groups can react not only with the hydroxyl groups of the polyols but also with any water present. Particularly in the case of high ambient humidity, this can trigger bubble formation and cause incomplete polymerization with chain terminations owing to only incompletely incorporated polyols, which leads to a greater or lesser loss of strength and elasticity. These problems barely occur in the case of use of mercury catalysts that very selectively catalyze the reaction with the polyols. Because of their high toxicity, however, mercury catalysts have no longer been usable for some time. As alternatives, two-component polyurethanes are often catalyzed with tin compounds and/or tertiary amines, but these are significantly less selective, which means that bubbles can form especially in the case of high ambient humidity. Higher selectivity is possessed by bismuth catalysts or zirconium catalysts; but these and other alternative metal catalysts are sensitive to hydrolysis, which means that the catalytic activity is largely lost, which can lead in turn to curing defects. Likewise widely used are reactive polymer compositions based on silane-functional polymers (SMP/STP) and silicones. These polymer systems cure via hydrolysis and condensation of silane groups, with release of alcohols, in particular methanol or ethanol, or oximes, which are toxic and cause VOC emissions; in addition, they usually contain large amounts of low molecular weight silanes as crosslinkers or desiccants, which are likewise harmful to health. Because of the moisture sensitivity of the silane groups, these polymer systems are also demanding in terms of production and use and do not always lead to the desired results.

Also known are water-based polymer systems, which are usually based on acrylate dispersions or polyurethane dispersions. These cure via evaporation of water and coalescence, and are largely free of chemical reactive groups. However, they can be used only in relatively thin layers and only between open-pore substrates, the rate of curing is highly dependent on ambient humidity, and they have high shrinkage. After curing, water sensitivity is elevated because of the surfactants present, which are needed for production and stability of the dispersion, and this can lead to reduced durability, especially in outdoor applications.

US 2018/0282477 describes the use of polyesters containing malonate groups for the crosslinking of compounds having activated C═C double bonds, such as, in particular, acrylates or methacrylates. With use of specific catalysts, this forms coatings of high hardness and barely any elasticity.

### SUMMARY OF THE INVENTION

It is therefore an object of the present invention to provide a novel polymer composition which is curable at room temperature and which is suitable as elastic adhesive, sealant or coating, and overcomes the disadvantages of the known polymer systems.

This object is surprisingly achieved by a curable composition as described in claim 1. The composition comprises a first component containing compounds containing aldehyde groups and a second component containing compounds containing malonate groups, where the average molecular weight Mₙ of at least one of the two components in relation to the compounds containing aldehyde or malonate groups is in the range from 400 to 20′000 g/mol. This composition has several advantageous and surprising properties with respect to room temperature-curable polymer systems according to the prior art.

Both the compounds containing aldehyde groups and the compounds containing malonate groups are substances of low toxicological concern that do not require hazard labeling and can be handled without special precautions. The composition of the invention is not sensitive to moisture and bubble formation and enables a high degree of freedom in formulation, since it is possible to use additives that are customarily used in curable compositions in both components without causing problems with the storage stability of the respective component. Surprisingly, the composition is very tolerant in relation to the stoichiometry of the reactive groups, in that a cured, non-tacky material of high extensibility and strength and good stability to heat and water is formed in each case at a ratio of the number of malonate groups to the number of aldehyde groups over the whole range from 1 to 2 or more. This is very surprising, given that reactive systems according to the prior art typically show a significant drop in mechanical quality in the case of any great variances from the optimal stoichiometry of the reactive groups, which is usually close to 1:1. For those reasons, the mixing ratio of the two components is adjustable almost as desired, which enables a great degree of freedom in the application method and simple, very reliable processing with high error tolerance. The composition has good processibility under ambient conditions without requiring organic solvents for dissolution or thinning or water for emulsification or dispersion of constituents. The composition cures surprisingly rapidly and faultlessly under ambient conditions irrespective of humidity and without causing emissions. It is particularly advantageous here that the curing rate is very efficiently controllable with customary catalysts, especially nonmetallic bases such as tertiary amines, amidines or guanidines. The curing gives rise to a nontacky elastic polymer of high strength and extensibility, with good tear propagation resistance and stability to heat and water. By virtue of the combination of these advantageous properties, the composition of the invention has particularly simple handling without special protective measures, and high robustness and long life, both in the production and storage of the components, in the use thereof in a broad range of ambient and application conditions, and in the event of fluctuations in the mixing ratio, and after curing under mechanical, thermal or chemical stress.

The composition of the invention is thus of very good suitability for use as a high-quality elastic adhesive, sealant or coating.

Further aspects of the invention are the subject of further independent claims.

Particularly preferred embodiments of the invention are the subject of the dependent claims.

### Ways of Executing the Invention

The invention provides a curable composition comprising
a first component containing compounds containing aldehyde groups, comprising at least one compound having two or more aldehyde groups, and
a second component containing compounds containing malonate groups, comprising at least one compound having two or more malonate groups of the formula (I)

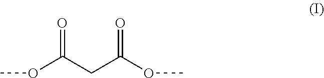

where the average molecular weight Mₙ of at least one of the two components in relation to the compounds containing aldehyde or malonate groups is in the range from 400 to 20′000 g/mol.

“Aldehyde groups” refer to functional groups of the formula

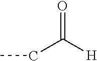

that are bonded via the dotted line.

A dotted line in the formulae in this document in each case represents the bond between a substituent and the corresponding remainder of the molecule.

“Molecular weight” refers to the molar mass (in grams per mole) of a molecule. “Average molecular weight” refers to the number-average molecular weight (Mₙ) of a polydisperse mixture of oligomeric or polymeric molecules. It is determined by gel-permeation chromatography (GPC) against polystyrene as standard.

A “storage stable” composition refers to one that can be stored at room temperature in a suitable container over a prolonged period, typically over at least 3 months up to 6 months or more, without this storage resulting in any change in its application or use properties to an extent relevant to its use.

Substance names beginning with “poly”, such as polymalonate, polyaldehyde or polyol, refer to substances containing, in a formal sense, two or more of the functional groups that occur in their name per molecule.

“Room temperature” refers to a temperature of 23° C.

All industry standards and norms mentioned in this document relate to the versions valid at the date of first filing.

Percentages by weight (% by weight) refer to proportions by mass of a constituent of a composition or a molecule, based on the overall composition or the overall molecule, unless stated otherwise. The terms “mass” and “weight” are used synonymously in the present document.

The first and second components of the curable composition are intrinsically storage-stable and are stored in separate containers until they are mixed with one another shortly before or during application.

In the curable composition, the average molecular weight Mₙ of at least one of the two components in relation to the compounds containing aldehyde or malonate groups is in the range from 400 to 20′000 g/mol. Such a composition cures to give an elastic polymer of high strength.

Preferably, at least one of the two components has an average molecular weight Mₙ in relation to the compounds containing aldehyde groups or containing malonate groups in the range from 1′000 to 20′000 g/mol, preferably 1′500 to 15′000 g/mol, especially 2′000 to 10′000 g/mol. This enables particularly high extensibility.

The compound having two or more aldehyde groups is preferably liquid at room temperature. In particular, it has a viscosity at 20° C. of 0.2 to 700 Pas, preferably 0.3 to 500 Pa·s, more preferably 0.5 to 200 Pas, especially 1 to 100 Pa·s, measured by cone-plate viscometer with cone diameter 10 mm, cone angle 1°, cone tip-plate distance 0.05 mm, shear rate 10 s⁻¹, and with cone diameter 50 mm for viscosities of less than 1 Pa·s. Such compounds are readily workable at ambient temperatures even without addition of solvents or thinners.

Preferred compounds having two or more aldehyde groups are polymers having aldehyde groups.

Preferably, the average molecular weight Mₙ of the first component in relation to the compounds containing aldehyde groups is in the range from 1′000 to 20′000 g/mol, preferably 1′500 to 15′000 g/mol, especially 2′000 to 10′000 g/mol, measured by gel permeation chromatography (GPC) versus polystyrene as standard. Such a component is readily workable at ambient temperatures even without addition of solvents or thinners and enables polymers having high extensibility and elasticity.

Preferably, the average aldehyde functionality of the compounds containing aldehyde groups is in the range from 1.6 to 4, preferably 1.8 to 3.5, more preferably 2.0 to 3.0, especially 2.2 to 3.0. This enables cured compositions having high extensibility, strength and stability.

The compounds containing aldehyde groups preferably comprise a polymer having a polymer backbone containing poly(oxyalkylene) units and/or polyester units.

Preferred poly(oxyalkylene) is poly(oxyethylene), poly(oxy-1,2-propylene), poly(oxy-1,3-propylene), poly(oxy-1,4-butylene), poly(oxy-1,2-butylene) or a mixed form of these poly(oxyalkylenes). Among these, preference is given to poly(oxy-1,2-propylene), poly(oxy-1,3-propylene) or poly(oxy-1,4-butylene), especially poly(oxy-1,2-propylene), where the latter may contain a content of 0% to 25% by weight of poly(oxyethylene) units based on the poly(oxyalkylene) backbone, especially at the chain ends. Aldehyde-functional polymers having such a backbone are of low viscosity and hence particularly efficiently workable and particularly hydrophobic. They enable compositions having particularly good processibility, high extensibility and good water resistance.

Preferred polyesters are esters of dicarboxylic acids and di- or triols, triglycerides or polyesters based on dimer or trimer fatty acids. Particular preference is given to polyesters of dimer fatty acids or derived from castor oil, derivatives of castor oil or vegetable oils. Aldehyde-functional polymers having such a backbone are particularly hydrophobic and enable compositions having particularly high resistance to heat and water. They are also based on renewable raw materials and are thus particularly sustainable.

The compound having two or more aldehyde groups preferably additionally contains urethane groups. This affords compositions having particularly high extensibility.

Preferably, the compounds containing aldehyde groups comprise a polymer containing urethane groups which is liquid at room temperature and has an average molecular weight Mₙ of 1′000 to 20′000 g/mol, preferably 1′500 to 15′000 g/mol, especially 2′000 to 10′000 g/mol, and an average aldehyde functionality of 1.8 to 3.5, more preferably 2.0 to 3.0, especially 2.2 to 3.0.

Preferably, the compound having two or more aldehyde groups is obtained from the reaction of at least one hydroxyaldehyde with at least one polymer containing isocyanate groups or at least one polyisocyanate.

Suitable hydroxyaldehydes are especially compounds having a molecular weight in the range from 60 to 500 g/mol, preferably 60 to 250 g/mol.

The following are especially suitable: 2-hydroxyacetaldehyde, 3-hydroxybutanal, 3-hydroxypivalaldehyde, 5-hydroxypentanal, 2-(2-hydroxyethoxy)acetaldehyde, 3-(2-hydroxyethoxy)propanal, 5-hydroxymethylfurfural, alkoxylated o-, m- or p-hydroxybenzaldehyde or alkoxylated vanillin, where “alkoxylated” preferably means (singly or multiply) “ethoxylated” or “propoxylated”, and 4,4′-(2-hydroxypropane-1,3-diyl)bis(oxy)bis(benzaldehyde) or 4,4′-(2-hydroxypropane-1,3-diyl)bis(oxy)bis(3-methoxybenzaldehyde).

Preference is given to ethoxylated salicylaldehyde, especially 2-(2-hydroxyethoxy)benzaldehyde, ethoxylated vanillin, especially 4-(2-hydroxyethoxy)-3-methoxybenzaldehyde, 5-hydroxymethylfurfural, N′-2-hydroxyethyl-N-piperazinyl-2,2-dimethylpropanal or N′-3-hydroxypropyl-N-piperazinyl-2,2-dimethylpropanal. These hydroxyaldehydes are obtainable in simple methods and enable compounds containing aldehyde groups and having low viscosity and hence good workability and compositions having good processibility and high strength coupled with high extensibility.

A particularly preferred hydroxyaldehyde is 5-hydroxymethylfurfural. This hydroxyaldehyde is obtainable from renewable raw materials and surprisingly enables particularly low-viscosity compounds having aldehyde groups and curable compositions having particularly good processibility and high strength, extensibility and resistance to heat and water.

Suitable polymers containing isocyanate groups for preparation of compounds having two or more aldehyde groups are especially reaction products of polyols with diisocyanates, especially in a molar NCO/OH ratio of 1.5/1 to 10/1, optionally with removal of unconverted monomeric diisocyanates from the polymer. The polymer containing isocyanate groups preferably has a content of free isocyanate groups in the range from 0.5% to 15% by weight, more preferably 1% to 10% by weight, especially 1.5% to 6% by weight, based on the polymer containing isocyanate groups.

A very particularly preferred polymer containing isocyanate groups is a reaction product from the reaction of at least one diisocyanate and at least one polyol in an NCO/OH ratio of at least 3/1, preferably 3/1 to 10/1, especially 4/1 to 8/1, followed by removal of a majority of the monomeric diisocyanate by a suitable separation method, such that the polymer containing isocyanate groups ultimately has a monomeric diisocyanate content of not more than 0.2% by weight based on the polymer containing isocyanate groups.

Such a polymer containing isocyanate groups enables aldehyde-functional polymers having a particularly low content of reaction products of monomeric diisocyanate and hydroxyaldehyde, especially less than 0.5% by weight of these reaction products based on the aldehyde-functional polymer. This enables curable compositions having particularly simple processing with long open time and rapid curing and particularly good flexibility.

A suitable diisocyanate is in particular hexane 1,6-diisocyanate (HDI), 2,2(4),4-trimethylhexane 1,6-diisocyanate (TMDI), 1-methyl-2,4(6)-diisocyanatocyclohexane (H₆TDI), isophorone diisocyanate (IPDI), 4,4′-diisocyanatodicyclohexylmethane (H₁₂MDI), 4(2),4′-diphenylmethane diisocyanate (MDI) or toluene 2,4(6)-diisocyanate. Preference is given to HDI, IPDI, TDI or MDI. Particular preference is given to IPDI. This affords compositions of particularly good processibility that cure to give polymers having high strength and extensibility.

Suitable polyols are especially
polyether polyols, especially polyoxyalkylene diols or polyoxyalkylene triols, especially polymerization products of ethylene oxide or 1,2-propylene oxide or 1,2- or 2,3-butylene oxide or oxetane or tetrahydrofuran or mixtures thereof, where these may be polymerized with the aid of a starter molecule having two or more active hydrogen atoms, especially a starter molecule such as water, ammonia or a compound having two or more OH or NH groups, for example ethane-1,2-diol, propane-1,2- or -1,3-diol, neopentyl glycol, diethylene glycol, triethylene glycol, the isomeric dipropylene glycols or tripropylene glycols, the isomeric butanediols, pentanediols, hexanediols, heptanediols, octanediols, nonanediols, decanediols, undecanediols, cyclohexane-1,3- or -1,4-dimethanol, bisphenol A, hydrogenated bisphenol A, 1,1,1-trimethylolethane, 1,1,1-trimethylolpropane, glycerol or aniline, or mixtures of the abovementioned compounds.

Preferred polyether polyols are polyoxypropylene diols or polyoxypropylene triols, or what are called ethylene oxide-terminated (EO-endcapped or EO-tipped) polyoxypropylene diols or triols. The latter are polyoxyethylene-polyoxypropylene copolyols, which are especially obtained by further alkoxylating polyoxypropylene diols or triols with ethylene oxide on conclusion of the propoxylation reaction, as a result of which they ultimately have primary hydroxyl groups.

Preferred polyether polyols have a degree of unsaturation of less than 0.02 meq/g, especially less than 0.01 meq/g.
Polyester polyols, especially those from the polycondensation of hydroxycarboxylic acids or lactones or the polycondensation of aliphatic and/or aromatic polycarboxylic acids with di- or polyhydric alcohols. Preference is given to amorphous, dimer or trimer fatty acid-based polyester polyols as are commercially available, for example, from Croda.
polycarbonate polyols, obtainable for example by reaction of diols with dialkyl carbonates, diaryl carbonates or phosgene.
Block copolymers bearing at least two hydroxyl groups, especially polyether polyester polyols.
Polyacrylate polyols and polymethacrylate polyols.
Polyhydroxy-functional fats or oils, especially natural fats or oils, such as, in particular, castor oil, derivatives of castor oil; or polyols obtained by chemical modification of natural fats and oils—called oleochemical polyols—for example hydroxylated vegetable oils obtainable under the Sovermol® trade name (from BASF).
Polyhydrocarbon polyols, such as, in particular, polyhydroxy-functional polyolefins, polyisobutylenes, polyisoprenes; polyhydroxy-functional ethylene/propylene, ethylene/butylene or ethylene/propylene/diene copolymers, as produced, for example, by Kraton Polymers; polyhydroxy-functional polymers of dienes, especially of 1,3-butadiene, which can especially also be prepared from anionic polymerization; polyhydroxy-functional copolymers of dienes, such as 1,3-butadiene, or diene mixtures and vinyl monomers, such as styrene, acrylonitrile, vinyl chloride, vinyl acetate, vinyl alcohol, isobutylene and isoprene, for example polyhydroxy-functional acrylonitrile/butadiene copolymers, as can be prepared, for example, from epoxides or aminoalcohols and carboxyl-terminated acrylonitrile/butadiene copolymers (commercially available, for example, under the Hypro® CTBN or CTBNX or ETBN name from Emerald Performance Materials); and hydrogenated polyhydroxy-functional polymers or copolymers of dienes.

Preference is given to polyols that are liquid at room temperature.

Preference is given to polyols having an OH number in the range from 9 to 115 mg KOH/g, preferably 14 to 60 mg KOH/g, especially 18 to 40 mg KOH/g.

Particular preference is given to polyether polyols, dimer or trimer fatty acid-based polyester polyols, castor oil, derivatives of castor oil or hydroxylated vegetable oils. Most preferred are polyether polyols.

Likewise suitable as the compound having two or more aldehyde groups are reaction products of at least one polyisocyanate with at least one hydroxyaldehyde, especially the aforementioned hydroxyaldehydes.

Suitable polyisocyanates are especially oligomeric diisocyanates, especially HDI biurets such as Desmodur® N 100 or N 3200 (from Covestro), Tolonate® HDB or HDB-LV (from Vencorex) or Duranate® 24A-100 (from Asahi Kasei); HDI isocyanurates such as Desmodur® N 3300, N 3600 or N 3790 BA (all from Covestro), Tolonate® HDT, HDT-LV or HDT-LV2 (from Vencorex), Duranate® TPA-100 or THA-100 (from Asahi Kasei) or Coronate® HX (from Nippon Polyurethane); HDI uretdiones such as Desmodur® N 3400 (from Covestro); HDI iminooxadiazinediones such as Desmodur® XP 2410 (from Covestro); HDI allophanates such as Desmodur® VP LS 2102 (from Covestro); IPDI isocyanurates, for example in solution as Desmodur® Z 4470 (from Covestro) or in solid form as Vestanat® T1890/100 (from Evonik); TDI oligomers such as Desmodur® IL (from Covestro); or mixed isocyanurates based on TDI/HDI, such as Desmodur® HL (from Covestro), where “HDI” stands for hexane 1,6-diisocyanate, “IPDI” for isophorone diisocyanate, and “TDI” for tolylene 2,4-diisocyanate or mixtures thereof with tolylene 2,6-diisocyanate. Preference is given to oligomeric diisocyanates derived from HDI, especially HDI biurets.

Preferably, the polymer containing isocyanate groups or the polyisocyanate and the hydroxyaldehyde are reacted in an OH/NCO ratio of 1/1 to 1.2/1 at a temperature of 40 to 140° C., preferably 60 to 120° C., optionally in the presence of a suitable catalyst.

In addition to polymers having aldehyde groups, the first component of the curable composition may contain proportions of low molecular weight polyaldehydes, such as, in particular, hexane-1,6-dialdehyde, heptane-1,7-dialdehyde, octane-1,8-dialdehyde, nonane-1,9-dialdehyde, 2-methyloctane-1,8-dialdehyde, decane-1,10-dialdehyde, undecane-1,11-dialdehyde, dodecane-1,12-dialdehyde, hexahydrophthalaldehyde, hexahydroisophthalaldehyde, hexahydroterephthalaldehyde, octahydro-4,7-methano-1H-indenedicarbaldehyde, 3,6,9-trioxaundecane-1,11-dial, 1,3-bis(2,2-dimethyl-3-oxopropyl)imidazolidin-2-one, N,N′-bis(2,2-dimethyl-3-oxopropyl)piperazine, N,N′-bis(2,2-dimethyl-3-oxopropyl) urea, phthalaldehyde, isophthalaldehyde, terephthalaldehyde, anthracene-9,10-dicarbaldehyde or naphthalenedicarboxaldehyde.

The curable composition comprises, as a constituent of the second component, at least one compound having two or more malonate groups of the formula (I)

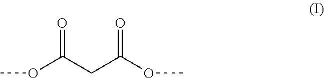

The compound having two or more malonate groups is preferably liquid at room temperature. In particular, it has a viscosity at 20° C. of 0.01 to 50 Pas, preferably 0.02 to 20 Pa·s, measured by cone-plate viscometer with cone diameter 10 mm, cone angle 1°, cone tip-plate distance 0.05 mm, shear rate 10 s⁻¹, and with cone diameter 50 mm for viscosities of less than 1 Pa·s. Such a compound is readily workable at ambient temperatures even without addition of solvents or thinners and enables efficiently processible compositions.

Preferably, the average functionality of the second component in relation to the compounds containing malonate groups is in the range from 1.6 to 6, preferably 1.8 to 5, especially 2.0 to 4. This enables cured compositions having high extensibility, strength and stability.

Preferably, the average molecular weight Mₙ of the second component in relation to the compounds containing malonate groups is in the range from 260 to 10′000 g/mol, preferably 300 to 3′000 g/mol. Such a second component enables particularly efficiently processible compositions of high strength.

Preferably, the compound having two or more malonate groups is obtained by reaction of at least one polyfunctional alcohol with malonic acid or at least one compound of the formula (II)

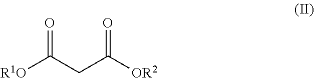

where R¹ and R² are each an alkyl radical having 1 to 6 carbon atoms.

Preferably, R¹ and R² are each methyl, ethyl or isopropyl, especially ethyl.

Suitable polyfunctional alcohols are commercial compounds or polymers having two or more OH groups, such as, in particular, ethane-1,2-diol, propane-1,2-diol, propane-1,3-diol, butane-1,4-diol, pentane-1,5-diol, hexane-1,6-diol, cyclohexane-1,3-dimethanol, cyclohexane-1,4-dimethanol, diethylene glycol, dipropylene glycol, 1,1,1-trimethylolpropane, glycerol, ethoxylated or especially propoxylated glycerol, ethoxylated or especially propoxylated 1,1,1-trimethylolpropane, castor oil, ethoxylated or especially propoxylated castor oil, ketone resin-modified castor oil, hydroxylated vegetable oils, dimer fatty acid diols or trimer fatty acid triols, dimer or trimer fatty acid-based amorphous polyester diols or triols, and the other polyols that have already been mentioned previously for production of a polymer containing isocyanate groups, especially poly(oxy-1,2-propylene)diols or -triols or ethylene oxide-endcapped poly(oxy-1,2-propylene)diols or -triols.

In particular, the polyfunctional alcohol is selected from the group consisting of ethane-1,2-diol, propane-1,2-diol, propane-1,3-diol, butane-1,4-diol, hexane-1,6-diol, cyclohexane-1,4-dimethanol, diethylene glycol, dipropylene glycol, glycerol, 1,1,1-trimethylolpropane, dimer fatty acid diols, trimer fatty acid triols, castor oil, poly(oxy-1,2-propylene)diols having an average molecular weight Mₙ of 300 to 2′000 g/mol, especially 300 to 1′000 g/mol, and propoxylated 1,1,1-trimethylolpropane having an average molecular weight Mₙ of 300 to 1′700 g/mol.

A preferred compound of the formula (II) is dimethyl malonate, diethyl malonate, diisopropyl malonate, butyl ethyl malonate, tert-butyl ethyl malonate or di-tert-butyl malonate. Particular preference is given to dimethyl malonate, diethyl malonate or diisopropyl malonate, especially diethyl malonate.

The reaction is preferably effected at a temperature in the range from 50 to 150° C. with distillative removal of the water or alcohol released, optionally under reduced pressure and optionally in the presence of catalysts.

In one embodiment, the reaction is conducted with at least one compound of the formula (II) and an excess of ester groups. The stoichiometry in this reaction is preferably in the range from 0.8 to 10 mol, especially 1 to 5 mol, of compounds of the formula (II) per molar equivalent of OH groups of the polyfunctional alcohol. This in particular forms a mixture of compounds having malonate groups, as shown by way of example in the formula below for a difunctional alcohol:

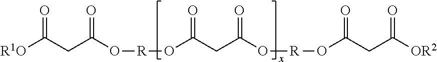

where R is the radical of the difunctional alcohol after removal of the two OH groups, x is 0 or a value from 1 to about 6, and R¹ and R² have the definitions already given.

The higher the excess of ester groups in the reaction was, the lower the average value of x. Preferably, unconverted compounds of the formula (II) are removed by distillation together with the alcohol R¹OH or R²OH released.

In a further embodiment, the reaction is preferably conducted with malonic acid and with an excess of OH groups. The stoichiometry here in the reaction is preferably in the range from 2.2 to 3.5, preferably 2.3 to 3.3, molar equivalents of OH groups of the polyfunctional alcohol per mole of malonic acid. This in particular forms a mixture of compounds having malonate groups, as shown by way of example in the formula below for a difunctional alcohol:

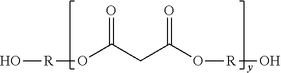

where R is the radical of the difunctional alcohol after removal of the two OH groups and y is a value from 1 to about 8, especially 2 to 6. The smaller the excess of OH groups in the reaction was, the higher the average value of y.

Likewise possible are reactions in which further substances are used as well. In one embodiment of the invention, at least one further dicarboxylic acid or at least one ester of a dicarboxylic acid is additionally used in the reaction, which is not malonic acid or an ester of malonic acid. This is preferred in particular in the case of a reaction with excess OH groups. A preferred further dicarboxylic acid is adipic acid or a dimer fatty acid.

A particularly preferred compound having two or more malonate groups is ethane-1,2-diol bis(ethylmalonate), propane-1,2-diol bis(ethylmalonate), propane-1,3-diol bis(ethylmalonate), butane-1,4-diol bis(ethylmalonate), hexane-1,6-diol bis(ethylmalonate), cyclohexane-1,4-dimethanol bis(ethylmalonate), diethylene glycol bis(ethylmalonate), dipropylene glycol bis(ethylmalonate), glycerol tris(ethylmalonate), 1,1,1-trimethylolpropane tris(ethylmalonate), dimer fatty acid diol bis(ethylmalonate), trimer fatty acid triol tris(ethylmalonate), castor oil tris(ethylmalonate), poly(oxy-1,2-propylene)diol bis(ethylmalonate) having an average molecular weight Mₙ of 500 to 2′000 g/mol, propoxylated 1,1,1-trimethylolpropane having three ethylmalonate end groups and an average molecular weight Mₙ of 650 to 2′500 g/mol, corresponding oligomeric compounds of these reaction products and polyester diols containing malonate groups from the reaction of diols such as hexane-1,6-diol or cyclohexane-1,4-dimethanol with malonic acid or diethyl malonates and optionally further dicarboxylic acids or esters thereof, such as, in particular, adipic acid or diethyl adipate or dimer fatty acids.

Suitable compounds having two or more malonate groups are also commercially available, especially as Acure® 510-200 (from Allnex).

Preferably, the average functionality of the overall composition in relation to the reactive aldehyde and malonate groups is at least 1.9, especially at least 2.0. This means that a composition having average aldehyde functionality in the first component of 1.8, for example, is preferably combined with a second component having average malonate functionality of at least 2.0, preferably at least 2.1, in order to achieve an overall average reactive group functionality of 1.9, preferably 2.0.

The curable composition may additionally contain further constituents, especially the following:
fillers, especially ground or precipitated calcium carbonates, optionally coated with fatty acids, especially stearates, barytes, quartz flours, quartz sands, dolomites, wollastonites, kaolins, calcined kaolins, sheet silicates, such as mica or talc, zeolites, aluminum hydroxides, magnesium hydroxides, silicas, including finely divided silicas from pyrolysis processes, industrially produced carbon blacks, graphite, metal powders, for example of aluminum, copper, iron, silver or steel, PVC powders or hollow beads;
fibers, in particular glass fibers, carbon fibers, metal fibers, ceramic fibers, hemp fibers, cellulose fibers or plastics fibers such as polyamide fibers or polyethylene fibers;
nanofillers such as graphene or carbon nanotubes;
dyes;
pigments, especially titanium dioxide, chromium oxide, iron oxides or organic pigments;
plasticizers, especially phthalates, especially diisononyl phthalate (DINP), diisodecyl phthalate (DIDP) or di(2-propylheptyl) phthalate (DPHP), hydrogenated phthalates, especially diisononyl cyclohexane-1,2-dicarboxylate (DINCH), terephthalates, especially bis(2-ethylhexyl) terephthalate or diisononyl terephthalate (DINT), hydrogenated terephthalates, especially bis(2-ethylhexyl) cyclohexane-1,4-dicarboxylate or diisononyl cyclohexane-1,4-dicarboxylate, isophthalates, trimellitates, adipates, especially dioctyl adipate (DOA), azelates, sebacates, benzoates, glycol ethers, glycol esters, plasticizers having polyether structure, especially polypropylene oxide monools, diols or triols, or polypropylene oxide monools, diols or triols having blocked hydroxyl groups, especially in the form of acetate groups, and organic sulfonates or phosphates, especially diphenyl cresyl phosphate (DPK), polybutenes, polyisobutenes or plasticizers derived from natural fats or oils, especially epoxidized soybean oil or linseed oil, especially phthalates, hydrogenated phthalates, adipates or plasticizers having polyether structure;
solvents;
modifiers such as hydrocarbon resins, natural or synthetic waxes or bitumen;
rheology modifiers, especially urea compounds, sheet silicates such as bentonites, derivatives of castor oil, hydrogenated castor oil, polyamides, polyurethanes, fumed silicas or hydrophobically modified polyoxyethylenes;
desiccants, especially molecular sieves, calcium oxide, monooxazolidines such as Incozol® 2 (from Incorez) or orthoformic esters;
adhesion promoters, especially titanates or organoalkoxysilanes such as aminosilanes, mercaptosilanes, epoxysilanes, vinylsilanes, (meth)acrylosilanes, carbamatosilanes, alkylsilanes, S-(alkylcarbonyl)mercaptosilanes or oligomeric forms of these silanes;
catalysts, especially nonmetallic bases such as tertiary amines, especially 2-dimethylaminoethyl ether, 2,2′-dimorpholinodiethyl ether (DMDEE) or 1,4-diazabicyclo[2.2.2]octane (DABCO), amidines, especially 1,8-diazabicyclo[5.4.0]undec-7-ene (DBU), 1,5-diazabicyclo[4.3.0]non-5-ene (DBN) or 1-(2-hydroxy-3-(3-trimethoxysilylpropoxy)prop-1-yl)-2-methyl-1,4,5,6-tetrahydropyrimidine, or guanidines, especially 1,1,3,3-tetramethylguanidine, 1-hexyl-2,3-diisopropylguanidine or 1,1′-(α,ω-polyoxypropylene)bis(2,3-diisopropylguanidine) having average molecular weight Mₙ of about 250 to 500 g/mol, and in particular basic salts such as, in particular, potassium acetate, potassium benzoate, potassium carbonate, potassium hydrogen carbonate, potassium phosphates, and the corresponding salts with sodium or lithium in place of potassium, where such basic salts are preferably used in the form of aqueous solutions, for example having a concentration of 10% to 30% by weight of the salt based on the total weight of the solution;
nonreactive thermoplastic polymers, such as homo- or copolymers of unsaturated monomers, especially from the group comprising ethylene, propylene, butylene, isobutylene, isoprene, vinyl acetate and alkyl (meth)acrylates, especially polyethylenes (PE), polypropylenes (PP), polyisobutylenes, ethylene-vinyl acetate copolymers (EVA) and atactic poly-α-olefins (APAO);
flame-retardant substances, especially the aluminum hydroxide or magnesium hydroxide fillers already mentioned, organic phosphoric esters, ammonium polyphosphates, melamine or derivatives thereof, boron compounds or antimony compounds;
additives, especially wetting agents, leveling agents, defoamers, deaerators, stabilizers against oxidation, heat, light or UV radiation, or biocides;
   and other substances customarily used in curable compositions.

Such additions may be present as constituents of the first or of the second component. Substances reactive with 1,3-ketoester groups are preferably a constituent of the first component. Substances reactive with aldehyde groups are preferably a constituent of the second component.

The curable composition preferably additionally contains at least one further constituent selected from plasticizers, fillers and catalysts. The curable composition preferably contains several such further constituents.

The curable composition preferably contains at least one basic catalyst having a pKa of at least 8, preferably at least 8.5, especially a nitrogen compound or an aqueous solution of a basic salt. Such a composition exhibits particularly rapid curing.

In a preferred embodiment of the invention, the curable composition, based on the overall composition, contains 10% to 95% by weight, preferably 20% to 90% by weight, especially 30% to 80% by weight, of fillers. Preference is given to fillers selected from calcium carbonates, baryte, quartz flour, quartz sand, kaolin, aluminum hydroxide, titanium dioxide and carbon black. Such a composition is particularly suitable for applications in layer thicknesses of at least 1 mm, preferably 1 to 500 mm, especially 1.5 to 250 mm. The cured composition exhibits markedly elastic properties.

In a further preferred embodiment of the invention, the curable composition, based on the overall composition, contains 5% to 80% by weight, especially 10% to 60% by weight, of plasticizers. Preference is given to plasticizers selected from DINP, DIDP, DPHP, DINCH, bis(2-ethylhexyl) terephthalate, DINT, bis(2-ethylhexyl) cyclohexane-1,4-dicarboxylate, diisononyl cyclohexane-1,4-dicarboxylate, DOA, polypropylene oxide monools, polypropylene oxide diols, polypropylene oxide triols, polypropylene oxide monoacetates, polypropylene oxide diol diacetates, polypropylene oxide triol triacetates and DPK.

In a particularly preferred embodiment of the invention, the curable composition contains fillers and plasticizers, especially, based on the overall composition, 20% to 90% by weight, especially 30% to 80% by weight, of fillers and 5% to 60% by weight of plasticizers.

The curable composition preferably contains less than 10% by weight, more preferably less than 5% by weight, especially less than 1% by weight, of volatile organic solvents having a boiling point at standard pressure of less than 250° C., based on the overall composition. Such a composition causes a particularly low level of emissions.

A suitable solvent is especially also a compound of the formula (II) such as, in particular, diethyl malonate, where this can be incorporated into the cured polymer by reaction in the course of curing.

The curable composition is preferably not water-based. It is preferably largely free of water or contains only a small content of water. Such a composition cures rapidly irrespective of ambient humidity, can be used in thick layers and/or between watertight substrates and shows barely any shrinkage on curing.

Preferably, the curable composition contains less than 10% by weight, preferably less than 5% by weight, in particular less than 2% by weight, of water, based on the overall composition.

The curable composition is preferably free of compounds having aldehyde or malonate groups that take the form of an emulsion or dispersion. The compounds having aldehyde or malonate groups present are thus preferably largely free of ionic groups or precursors thereof, and largely free of relatively long poly(oxyethylene) chains as are customary in surfactants. Such a composition has high resistance to water. In particular, the compounds containing aldehyde groups in the first component and the compounds containing malonate groups in the second component each have a content of acid groups or ionic groups of less than 0.1% by weight, preferably less than 0.05% by weight, based on the compounds containing aldehyde groups or the compounds containing malonate groups. The ionic groups are especially carboxylate groups, ammonium groups or sulfonate groups.

The first component of the curable composition is preferably free of aldimine groups or contains only a low content of aldimine groups of less than 0.2 mol, especially less than 0.1 mol, of aldimine groups per mole of malonate groups in the second component. This means that the first component is largely free of primary amines. Primary amino groups react with aldehydes to give aldimines. It is not within the scope of the present invention to convert the aldehyde groups in the first component to aldimine groups. The curable composition of the invention is cured mainly by reaction of malonate groups with free aldehyde groups.

The curable composition preferably comprises a total of
5% to 100% by weight, preferably 10% to 70% by weight, of the sum total of compounds having aldehyde groups or malonate groups of the formula (I),
0% to 50% by weight, preferably 10% to 40% by weight, of plasticizers,
0% to 90% by weight, preferably 20% to 80% by weight, of fillers,
and optionally further substances,
   based on the overall composition.

In the curable composition, the ratio of the number of malonate groups to the number of aldehyde groups is preferably in the range from 0.5 to 2.5, more preferably 0.8 to 2.2, especially 1 to 2. Such a ratio enables rapid, faultless curing to give a mechanically high-quality polymer having high strength, extensibility and stability. It is a particularly surprising fact that the ratio can be varied within such a range, and a nontacky material having good mechanical properties is always obtained. This means that the composition is particularly robust in relation to fluctuations in the mixing ratio of the two components during processing.

The consistency of the first and second components of the curable composition is suitably such that the components can be mixed efficiently with one another by simple methods under ambient conditions. For this purpose, liquid or pasty components in particular are suitable.

The first and second components of the curable composition are produced separately from one another. The constituents of the respective component are mixed here with one another so as to give a macroscopically homogeneous mass. Each component is stored in a separate container. Suitable containers are especially a drum, a container, a hobbock, a bucket, a canister, a can, a pouch, a tubular pouch, a cartridge or a tube. The components are storage-stable.

For use of the curable composition, the two components and any further components present are mixed with one another shortly before or during the application. The mixing ratio is chosen here such that the ratio of the number of malonate groups to the number of aldehyde groups is within a suitable range, especially about 1 to 2. In parts by weight, the mixing ratio between the first and second components is typically in the range from about 100:1 to 1:5, especially 50:1 to 1:2.

If the components are mixed with one another prior to application, it must be ensured that not too much time passes between the mixing of the components and the application, since the onset of reaction and the associated rise in viscosity can otherwise lead to problems, for example inadequate leveling or delayed or incomplete adhesion to the substrate. More particularly, the open time of the composition should not be exceeded during the application.

“Open time” refers here to the time span between the mixing of the components and the end of a state of the composition suitable for processing.

The mixing is preferably effected at ambient temperature, especially at a temperature in the range from −5 to 50° C., especially 0 to 40° C.

The mixing of the two components commences curing of the composition via the onset of chemical reaction. It is mainly the malonate groups that react here with the aldehyde groups, as a result of which the composition cures ultimately to give a solid polymeric material. It may be expected that the curing reaction will form structural units of the formula

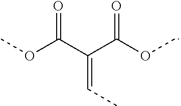

In addition, it may be expected that any other malonate group present will be able to add onto the C═C double bond formed and hence increase the crosslinking density.

The curing is preferably effected at ambient temperature, especially at a temperature in the range from −5 to 50° C., especially 0 to 40° C.

The invention further provides the cured composition obtained from the curable composition after the two components have been mixed.

The cured composition is preferably elastic and has high strength coupled with high extensibility.

For this purpose, the cured composition preferably has a tensile strength determined to DIN EN 53504 as described in the examples of at least 1 MPa, preferably at least 1.5 MPa, especially at least 2 MPa.

The cured composition preferably has an elongation at break, determined to DIN EN 53504 as described in the examples, of at least 50%, preferably at least 75%, more preferably at least 100%, especially preferably at least 150%, in particular at least 200%.

The cured composition preferably has a Shore A hardness, determined to DIN 53505 as described in the examples, in the range from 10 to 90, especially 20 to 80.

In addition, the cured composition has good resistance to heat and water. The cured composition, even after storage at 100° C. or at 70° C. at 100% relative humidity for 7 days, preferably has high strength, extensibility and hardness.

The curable composition is suitable for a multitude of uses. It can especially be used as adhesive, sealant, coating, casting resin or spackling compound.

The invention further provides for the use of the curable composition as elastic adhesive, elastic sealant or elastic coating, wherein the first and second and any further components present are mixed with one another, and the mixed composition is applied in the liquid state to at least one substrate.

In the case of use as elastic adhesive, elastic sealant or elastic coating, the layer thickness of the cured composition is preferably at least 1 mm, preferably 1 to 50 mm, especially 1.5 to 25 mm.

Suitable substrates are in particular:
glass, glass ceramic, concrete, mortar, cement screed, fiber cement, brick, tile, plaster or natural rocks such as granite or marble;
repair compounds or leveling compounds based on PCC (polymer-modified cement mortar) or ECC (epoxy resin-modified cement mortar);
metals or alloys such as aluminum, iron, steel, copper, other nonferrous metals, including surface-finished metals or alloys such as galvanized or chrome-plated metals;
asphalt or bitumen;
leather, textiles, paper, wood, wood-based materials bonded with resins, for example phenolic, melamine or epoxy resins, resin-textile composites or further polymer composites;
plastics, such as rigid and flexible PVC, polycarbonate, polystyrene, polyester, polyamide, PMMA, ABS, SAN, epoxy resins, phenolic resins, PUR, POM, TPO, PE, PP, EPM or EPDM, in each case untreated or surface-treated, for example by means of plasma, corona or flames;
fiber-reinforced plastics, such as carbon fiber-reinforced plastics (CFRP), glass fiber-reinforced plastics (GFRP), natural fiber-reinforced plastics (NFRP) and sheet molding compounds (SMC);
insulation foams, especially made of EPS, XPS, PUR, PIR, rock wool, glass wool, aerogel or foamed glass;
coated or painted substrates, especially painted tiles, coated concrete, powder-coated metals or alloys or painted metal sheets;
coatings, paints or varnishes.

The substrates can if required be pretreated prior to application, especially by physical and/or chemical cleaning methods or the application of an activator or a primer.

It is possible to bond and/or seal two identical or two different substrates.

The use of the curable composition affords an article. The article has especially been bonded, sealed or coated with the composition. This article may be a built structure or part thereof, especially a civil engineering structure built above or below ground, a bridge, a roof, a staircase or a facade, or it may be an industrial good or a consumer good, especially a window, a pipe, a rotor blade of a wind turbine, a domestic appliance or a mode of transport such as, in particular, an automobile, a bus, a truck, a rail vehicle, a ship, an aircraft or a helicopter, or an installable component thereof.

### EXAMPLES

Working examples are adduced hereinafter, which are intended to further elucidate the invention described. It will be apparent that the invention is not limited to these described working examples.

“Standard climatic conditions” (“SCC”) refers to a temperature of 23±1° C. and a relative air humidity of 50±5%.

The chemicals used were from Sigma-Aldrich Chemie GmbH, unless stated otherwise.

### Description of the Measurement Methods:

Viscosity was measured on a thermostated Rheotec RC30 cone-plate viscometer (cone diameter 10 mm, cone angle 1°, cone tip-plate distance 0.05 mm, shear rate s⁻¹). Viscosities of less than 1 Pas were measured with a cone diameter of 50 mm.

Infrared spectra (FT-IR) were measured as undiluted films on a Nicolet iS5 FT-IR instrument from Thermo Scientific equipped with a horizontal ATR measurement unit with a diamond crystal. Absorption bands are reported in wavenumbers (cm-1).

### Preparation of Polymers Containing Isocyanate Groups:

### Polymer P-1:

780 g of ethylene oxide-terminated polyoxypropylene triol (Desmophen® 5031 BT, OH number 28.0 mg KOH/g, OH functionality about 2.3, from Covestro) and 303 g of isophorone diisocyanate (Vestanat® IPDI, from Evonik) were converted at 80° C. by a known method to a reaction mixture having an NCO content of 9.1% by weight. Subsequently, the volatile constituents, in particular unconverted isophorone diisocyanate, were removed by distillation in a short-path evaporator (jacket temperature 160° C., pressure 0.1 to 0.005 mbar) to obtain a polymer having an NCO content of 1.84% by weight and a monomeric isophorone diisocyanate content of 0.02% by weight.

### Preparation of Compounds Having Two or More Aldehyde Groups:

### Compound A-1

500.0 g of polymer P-1 containing isocyanate groups was reacted in the presence of 0.1 g of dibutyltin dilaurate, with exclusion of moisture at 110° C., with 27.7 g of 5-hydroxymethylfurfural until no isocyanate groups were detectable any longer by IR spectroscopy. What was obtained was a clear, colorless liquid having a viscosity at 20° C. of 63.7 Pas, an average aldehyde functionality of 2.3 and a calculated aldehyde equivalent weight of 2381 g/eq.

The average molecular weight Mₙ of compound A-1 was additionally determined by gel permeation chromatography (GPC) versus polystyrene (474 to 2′520′000 g/mol) as standard with tetrahydrofuran as mobile phase and refractive index detector. The average molecular weight Mₙ was 6100 g/mol.

### Preparation of Compounds Having Two or More Malonate Groups:

### Compounds M-1 to M-6

For each of the compounds, the amount specified in table 1 (in parts by weight) of the particular polyfunctional alcohol was admixed with the specified amount (in parts by weight) of diethyl malonate and 0.1% by weight of tetra-n-butyl titanate (Tyzor® TnBT, from Dorf Ketal), and the mixture was converted at a temperature of 140° C. under reduced pressure and with removal of the volatile constituents. What was obtained in each case was a clear colorless liquid.

TABLE 1
Preparation and properties of compounds M-1 to M-6.

| Compound | M-1 | M-2 | M-3 | M-4 | M-5 | M-6 |
|---|---|---|---|---|---|---|
| PPG diol 400 ¹ | 213.3 | — | — | — | — | — |
| PPG triol 300 ² | — | 123.4 | — | — | — | — |
| Propylene glycol | — | — | 72.9 | — | — | — |
| Hexane-1,6-diol | — | — | — | 82.7 | — | — |
| Cyclohexane- | — | — | — | — | 86.5 | — |
| 1,4-dimethanol | | | | | | |
| Castor oil ³ | — | — | — | — | — | 204.0 |
| Diethyl malonate | 192.2 | 192.2 | 224.2 | 224.2 | 192.2 | 99.0 |
| Viscosity (20° C.) | 4.20 | 7.33 | 0.63 | 0.09 | 1.04 | 4.34 |
| [Pa · s] | | | | | | |
| Estimated malonate | 292 | 217 | 152 | 173 | 186 | 450 |
| equivalent weight | | | | | | |
| [g/eq] | | | | | | |

¹ polyoxypropylene diol (Voranol ® P400, OH number 263 mg KOH/g, from Dow)
² trimethylolpropane-started polyoxypropylene triol (Desmophen ® 4011T, OH number 550 mg KOH/g, from Covestro)
³ OH number 170 mg KOH/g

### Production of Curable Compositions:

### Examples Z-1 to Z-8

For each example, the ingredients of the first component (K1) that are specified in table 2 were mixed with one another in the specified amounts (in parts by weight) using a centrifugal mixer (SpeedMixer™ DAC 150, FlackTek Inc.) and stored in a closed container.

The ingredients of the second component (K2) that are specified in table 2 were likewise processed and stored.

The “precipitated CaCO₃” used was Socal® U1S2 (from Imerys), a precipitated and stearate-coated calcium carbonate.

The “carbon black” used was Monarch® 570 (from Cabot).

Subsequently, the two components of each composition were then processed using the centrifugal mixer to give a homogeneous paste, which was tested as described below.

Gel time was determined by stirring a freshly mixed amount of about 3 g under standard climatic conditions with a spatula at regular intervals until this was no longer possible as a result of gelation of the mass.

Mechanical properties were determined by applying the mixed composition to a silicone-coated release paper to give a film of thickness 2 mm, leaving the film to cure under standard climatic conditions for 7 days, punching a few dumbbell-shaped test specimens having a length of 75 mm with a bar length of 30 mm and a bar width of 4 mm out of the film and testing these in accordance with DIN EN 53504 at a strain rate of 200 mm/min for Tensile strength, Elongation at break and modulus of elasticity MoE 5% (at 0.5%-5% elongation) and MoE 50% (at 0.5%-50% elongation). Furthermore, a number of test specimens were punched out for determination of Tear propagation resistance and were tested in accordance with DIN ISO 34-1, Method B (angular test specimens) at a strain rate of 500 mm/min.

Shore A hardness was determined to DIN 53505 on test specimens cured under standard climatic conditions for 7 days. These results are given the addition “7 d SCC”. Resistance to heat and water was determined by storing further Shore A test specimens, after curing under standard climatic conditions for 7 days, either additionally in an air circulation oven at 100° C. for 7 days or additionally at 70° C. and 100% relative humidity for 7 days, cooling them down to room temperature and then determining Shore A hardness as described in each case. These results are given the addition “+7 d 100° C.” or “+7 d 70/100”.

The curing of the inventive examples in each case gave a nontacky, elastic material.

The results are reported in table 2.

TABLE 2
Composition and properties of Z-1 to Z-8.

| Example | Z-1 | Z-2 | Z-3 | Z-4 | Z-5 | Z-6 | Z-7 | Z-8 |
|---|---|---|---|---|---|---|---|---|
| Component K1: | | | | | | | | |
| Compound A-1 | 30.0 | 30.0 | 30.0 | 30.0 | 30.0 | 30.0 | 30.0 | 30.0 |
| Diisodecyl phthalate | 20.0 | 20.0 | 20.0 | 20.0 | 20.0 | 20.0 | 20.0 | 20.0 |
| Precipitated CaCO₃ | 30.0 | 30.0 | 30.0 | 30.0 | 30.0 | 30.0 | 30.0 | 30.0 |
| Carbon black | 10.0 | 10.0 | 10.0 | 10.0 | 10.0 | 10.0 | 10.0 | 10.0 |
| DBU ¹ | 0.6 | 0.6 | 0.6 | 0.6 | 0.6 | 0.6 | 0.6 | 0.6 |
| | M-1 | M-1 | M-1 | M-2 | M-3 | M-4 | M-5 | M-6 |
| Component K2: | | | | | | | | |
| Compound | 3.7 | 5.5 | 7.4 | 4.1 | 2.9 | 3.3 | 3.5 | 5.7 |
| Mal/Ald ratio ² | 1 | 1.5 | 2 | 1.5 | 1.5 | 1.5 | 1.5 | 1 |
| Gel time [min] | 180 | 90 | 70 | 5 | 5 | 70 | 80 | >180 |
| Tensile strength | 2.3 | 2.6 | 3.0 | 4.0 | 4.5 | 3.8 | 4.3 | 2.5 |
| [MPa] | | | | | | | | |
| Elongation at break | 246 | 173 | 155 | 144 | 207 | 166 | 191 | 285 |
| [%] | | | | | | | | |
| MoE 5% [MPa] | 1.3 | 2.3 | 3.1 | 4.5 | 3.7 | 3.9 | 4.0 | 1.1 |
| MoE 50% [MPa] | 0.9 | 1.6 | 2.1 | 2.7 | 2.4 | 2.4 | 2.3 | 0.8 |
| Tear propagation | 3.6 | 3.4 | 3.0 | 3.3 | 4.0 | 3.6 | 4.0 | 4.2 |
| resistance [N/mm] | | | | | | | | |
| Shore A (7 d SCC) | 36 | 48 | 54 | 60 | 56 | 59 | 59 | 34 |
| (+7 d 100° C.) | 49 | 51 | 50 | 53 | 54 | 58 | 58 | 49 |
| (+7 d 70/100) | 23 | 36 | 42 | 48 | 36 | 44 | 43 | 24 |

¹ 1,8-diazabicyclo[5.4.0]undec-7-ene (Lupragen ® N700, from BASF)
² estimated ratio of the number of malonate groups to aldehyde groups

1. A curable composition comprising
a first component containing compounds containing aldehyde groups, comprising at least one compound having two or more aldehyde groups, and
a second component containing compounds containing malonate groups, comprising at least one compound having two or more malonate groups of the formula (I) 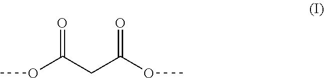
where the average molecular weight Mₙ of at least one of the two components in relation to the compounds containing aldehyde or malonate groups is in the range from 400 to 20′000 g/mol.

2. The composition as claimed in claim 1, wherein the compound having two or more aldehyde groups is liquid at room temperature, measured by cone-plate viscometer with cone diameter 10 mm, cone angle 1°, cone tip-plate distance 0.05 mm, shear rate 10 s⁻¹, and with cone diameter 50 mm for viscosities of less than 1 Pa·s.

3. The composition as claimed in claim 1, wherein the average molecular weight Mₙ of the first component in relation to the compounds containing aldehyde groups is in the range from 1′000 to 20′000 measured by gel permeation chromatography (GPC) versus polystyrene as standard.

4. The composition as claimed in claim 1, wherein the compounds containing aldehyde groups comprise a polymer having a polymer backbone containing poly(oxyalkylene) units and/or polyester units.

5. The composition as claimed in claim 1, wherein the compounds containing aldehyde groups comprise a polymer containing urethane groups which is liquid at room temperature and has an average molecular weight Mₙ of 1′000 to 20′000 g/mol, and an average aldehyde functionality of 1.8 to 3.5.

6. The composition as claimed in claim 1, wherein the compound having two or more aldehyde groups is obtained from the reaction of at least one hydroxyaldehyde with at least one polymer containing isocyanate groups or at least one polyisocyanate.

7. The composition as claimed in claim 1, wherein the compound having two or more malonate groups is liquid at room temperature.

8. The composition as claimed in claim 1, wherein the average functionality of the second component in relation to the compounds containing malonate groups is in the range from 1.6 to 6.

9. The composition as claimed in claim 1, wherein the compound having two or more malonate groups is obtained by reaction of at least one polyfunctional alcohol with malonic acid or at least one compound of the formula (II) 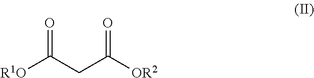
where R¹ and R² are each an alkyl radical having 1 to 6 carbon atoms.

10. The composition as claimed in claim 1, wherein, based on the overall composition, 10% to 95% by weight, of fillers is present.

11. The composition as claimed in claim 1, wherein, based on the overall composition, 5% to 80% by weight, of plasticizers is present.

12. The composition as claimed in claim 1, wherein less than 10% by weight, of volatile organic solvents having a boiling point at standard pressure of less than 250° C. is present, based on the overall composition.

13. A cured composition obtained from the curable composition as claimed in claim 1 after the two components have been mixed, wherein the cured composition has a tensile strength of at least 1 MPa, and/or an elongation at break of at least 75%, determined to DIN EN 53504 at a strain rate of 200 mm/min on dumbbell-shaped test specimens having a thickness of 2 mm and a length of 75 mm with a bar length of 30 mm and a bar width of 4 mm.

14. The method of the composition as claimed in claim 1 as elastic adhesive, elastic sealant or elastic coating, wherein the first and second and any further component present are mixed with one another, and the mixed composition is applied in the liquid state to at least one substrate.

15. The method as claimed in claim 14, wherein the cured composition has a layer thickness of at least 1 mm.
